(19) United States
(12) Patent Application Publication
(10) Pub. No.: US 2007/0249442 A1
(43) Pub. Date: Oct. 25, 2007

(54) Belt pulley with integrated torsional oscillation damper and process for producing same

(75) Inventors: Rudi Grunau, Neuenburg (DE); Benno-Michael Joerg, Obersaasheim (FR); Maik Tempke, Sexau (DE); Alexander Wick, Badenweiler (DE)

Correspondence Address: HARNESS, DICKEY & PIERCE, P.L.C., P.O. BOX 828, BLOOMFIELD HILLS, MI, 48303, US

(73) Assignee: Carl Freudenberg KG, Weinheim (DE)

(21) Appl. No.: 11/784,178

(22) Filed: Apr. 5, 2007

(30) Foreign Application Priority Data
Apr. 6, 2006 (DE) 10 2006 016 202.1

(51) Int. Cl. F16H 55/36; F16H 55/06; F16F 15/12

(52) U.S. Cl. 474/94; 474/161; 74/443; 74/574.4

(57) ABSTRACT

A belt pulley having an integrated torsional oscillation damper. The torsional oscillation damper comprises a hub ring that encloses a flywheel ring. A radial first space is formed between the hub ring and the flywheel ring, wherein a first spring body is arranged in a first gap formed by the radial first space. A bushing is disposed between the hub ring and the flywheel ring to form a radial second space, wherein a second spring body is arranged in a second gap formed by the second radial space.

### CROSS-REFERENCE TO RELATED APPLICATIONS

This application claims the benefit of German Patent Application 10 2006 016 202.1 filed Apr. 6, 2006. The disclosure of the above application is incorporated herein by reference in its entirety.

### FIELD

The present disclosure relates to a belt pulley having an integrated torsional oscillation damper, and to a process for producing the same.

### BACKGROUND

The statements in this section merely provide background information related to the present disclosure and may not constitute prior art.

Belt pulleys with integrated torsional oscillation damper are generally known, for example, from DE 100 13 699 C1. The integrated torsional oscillation damper of DE 100 13 699 is in the form of a viscous damper having a flywheel ring, which is disposed in a damper housing filled with a viscous medium and which can rotate relative to the same. The viscous damper axially adjoins the belt pulley, and the damper housing on the front side axially facing away from the belt pulley is sealed by a sealing plate in liquid-tight manner.

### SUMMARY

The present disclosure provides a belt pulley having an integrated torsional oscillation damper. The torsional oscillation damper comprises a hub ring that encloses a flywheel ring. A radial first space is formed between the hub ring and the flywheel ring, wherein a first spring body is arranged in a first gap formed by the radial first space. A bushing is disposed between the hub ring and the flywheel ring to form a radial second space, wherein a second spring body is arranged in a second gap formed by the second radial space.

The integrated torsional oscillation damper is a premountable unit formed of the hub ring, the first spring body, the flywheel, the second spring body, and the bushing. The premountable unit may be enclosed by the belt pulley, which may be pot-shaped. The pot-shaped belt pulley may comprise an axial flange having a belt track, and a radial flange. An inner peripheral surface of the axial flange may enclose in a rotation-resistant manner an outer peripheral surface of the bushing, wherein a damping space filled with a viscous medium may be defined by the pre-mountable unit and the belt pulley. A shearing gap filled with the viscous medium may be disposed between shearing surfaces of the flywheel ring and the radial flange that axially face one another and extend in a radial direction. Sealing of the damping space against the surroundings may be provided by a sealing ring formed on a radial inner side and an outer side of the damping space. The first sealing ring of the radial inner side of the damping space may be integral with the first spring body. The second sealing ring of the outer side of the damping space may be integral with the second spring body.

A belt pulley having an integrated torsional oscillation damper has a structure that consists of only a few parts and, therefore, may be produced in a simple and inexpensive manner. The premountable torsional oscillation damper and the pot-shaped belt pulley define the damping space filled with the viscous medium. Another advantage is that the torsional oscillation damper may be enclosed by the axial flange of the belt pulley so that the entire assembly has an axial width that, in essence, corresponds only to an axial width of the belt track. The dimensions of the belt pulley with the integrated torsional oscillation damper in the axial direction are, therefore, particularly compact.

The premountable unit that forms the torsional oscillation damper may be mounted into the belt pulley. Mounting integrated torsional oscillation damper to the belt pulley is carried out with a first processing step where the viscous medium may be introduced into the pot-shaped belt pulley. In a second processing step, the premountable unit may be inserted into the belt pulley filled with the medium. Due to the first and the second sealing rings for sealing the damping space against the surroundings being integral with the first and second spring bodies, respectively, the premountable unit automatically seals the damping space against the surroundings after the premountable unit has been inserted into the belt pulley. Furthermore, because the structure consists of only a few parts, the risk of mounting errors are prevented, or at least substantially minimized.

The integrated torsional oscillation damper may be press fit into the belt pulley. In such a case, the internal peripheral surface of the axial flange encloses the outer peripheral surface of the bushing by direct contact and in rotation-resistant manner.

Compared to torsional oscillation dampers without viscosity rotation damping, the belt pulley having an integrated torsional oscillation damper has an advantage in that the predominant part of the rotation damping is brought about by viscosity rotation damping. The spring bodies made of elastomeric material are thus exposed to only a slight mechanical and thermal load. The belt pulley having the integrated torsional oscillation damper, therefore, retains good use properties over a long service life.

Because the spring bodies delimit the damping space and, therefore, come in direct contact with the viscous medium of the torsional oscillation damper, the spring bodies may be made of a substance that is resistant to the viscous medium.

The spring bodies may be made of a synthetic rubber, and the medium in the damping space may be a silicone oil. Silicone oils are well suited to provide high damping efficiency even in high-powered passenger cars. Silicone oil is highly viscous. The damping space in which the fly-wheel ring is disposed is filled with the highly viscous silicone oil and is sealed against the surroundings by the sealing rings molded to or integral with the spring bodies.

The spring bodies may be made of a matching material. As a result, the premountable unit may be produced in a single processing step using a single vulcanization tool.

The spring bodies may be integral such that the shearing surface of the flywheel ring axially facing the radial flange may be covered with the material of the spring bodies. The spring bodies and/or the cover may be firmly bonded with the flywheel ring. The firm bond can be achieved by a vulcanization process. Covering the shearing surface of the flywheel ring with the elastomeric material of the spring bodies is advantageous in that the flywheel ring may become heat-insulated, and the heat generated by the torsional oscillation damping may be forced to be dissipated to the surroundings essentially by way of the shearing surface of the belt pulley.

The cover of the shearing surface of the flywheel ring may, on the side axially facing the radial flange of the belt pulley, be provided with elevations extending in the direction of the radial flange and which, under elastic pretension, may come in contact with the shearing surface of the radial flange and are therefore configured as bearings. It is thus possible to tighten the flywheel against the shearing surface of the belt pulley and permanently set the shearing gap to an axial width that corresponds to the axial height of the elevations. Regardless of the action of hydraulic pressure, the axial width of the shearing gap of the elevations configured as bearings may remain virtually constant during normal use of the belt pulley having the integrated torsional oscillation damper.

The spring bodies viewed in longitudinal section may be rectangular. The spring bodies may thus be optimized in terms of tension and stretching.

The spring bodies may extend in the axial direction over nearly an entire structural height of the belt pulley to optimize a size of the bonding surfaces between the elastomeric spring bodies and the hub ring, the flywheel ring, and the bushing so that the shearing stress in the boundary layers of the bonding surfaces is minimized. The extension of the spring bodies in the radial direction may be sized to be sufficiently large so that shearing elongations that may appear in the spring bodies may be reliably controlled.

According to another configuration, at least one spring body viewed in longitudinal section may have a trapezoidal shape, with the spring body showing a greater radial thickness on the side facing axially away from the radial flange than on the side facing the radial flange. When the spring body heats up during normal use of the belt pulley, back-pressure forces may build up as a result of heat-induced stretching in the elastomeric material of the spring bodies. These back-pressure forces may hold the flywheel ring essentially in its axial position, even when at higher rotational speeds as a result of the hydraulic pressure, the flywheel ring may tends to drift in the axial direction.

Under elastic pretension, the first sealing ring may be disposed in sealing manner between the hub ring and the radial flange. The second sealing ring may under elastic pretension be disposed in sealing manner between the bushing and the belt pulley. By such an arrangement of the two sealing rings, a sufficiently large volume of the damping space filled with the viscous medium may be achieved despite the very compact configuration of the belt pulley in the axial direction. This prevents the medium from attaining undesirably high temperatures during operation.

The belt pulley and the hub ring may be linked to each other in rotation-resistant manner. A relative movement in the peripheral direction toward the belt pulley, and thus also toward the hub ring, may occur only by way of the flywheel ring, which by the two spring bodies is disposed in torsionally elastic manner relative to the hub ring and the belt pulley.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 illustrates a belt pulley having an integrated torsional oscillation damper according to the present disclosure, wherein the two spring bodies, viewed in longitudinal section, have an essentially rectangular shape; and

FIG. 2 illustrates a belt pulley having an integrated torsional oscillation damper according to the present disclosure, wherein a spring body has a trapezoidal shape.

### DETAILED DESCRIPTION

The following description is merely exemplary in nature and is not intended to limit the present disclosure, application, or uses.

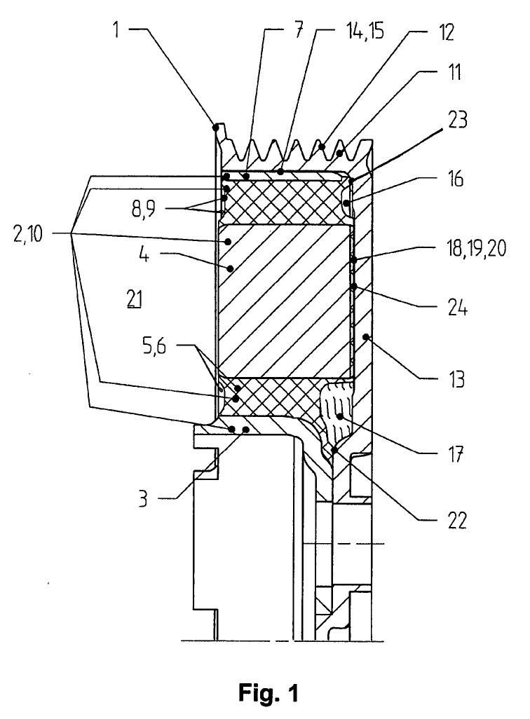

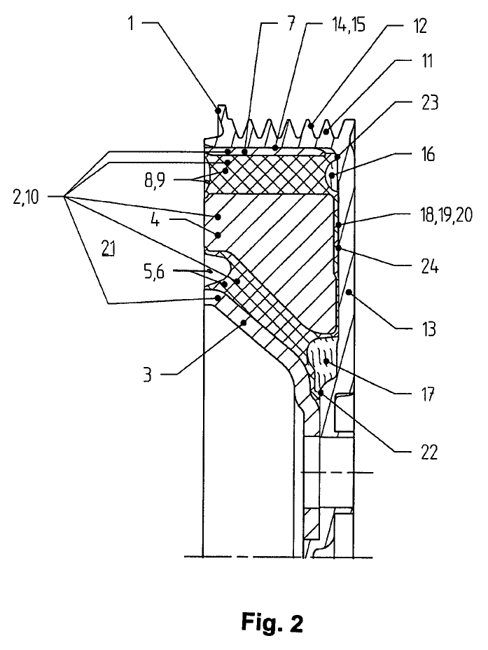

FIGS. 1 and 2 illustrate a belt pulley 1 having an integrated torsional oscillation damper 2.

Belt pulley 1 having integrated torsional oscillation damper 2 may be used, for example, on crank-shafts of reciprocating engines to dampen rotary oscillations of the crankshaft.

Oscillation damping is based on a functionally parallel connection of two spring bodies 6 and 9 with a shearing effect, during normal use of the belt pulley, acting on a viscous medium 16 disposed within the shearing gap 20.

Torsional oscillation damper 2 may be a premountable unit 10 including a hub ring 3, a first spring body 6, a flywheel ring 4, a second spring body 9, and a bushing 7. Hub ring 3 may be enclosed at a first radial distance by flywheel ring 4. First spring body 6 may be disposed in a first gap 5 formed by the first distance. On an outer peripheral side, flywheel ring 4 may be enclosed by a radial second distance. Second spring body 9 may be disposed in a second gap 8 formed by the second distance.

First and second spring bodies 6 and 9 may be integral due to a cover 24 formed on shearing surface 18 of flywheel ring 4.

First and second spring bodies 6 and 9 and cover 24 may be configured in materially uniform manner and firmly bonded with flywheel ring 4 by vulcanization.

Belt pulley 1 may be pot-shaped having an axial flange 11, which radially on an outer peripheral side may be provided with a belt track 12. On a front face, the axial flange 11 may be bonded on one side with a radial flange 13. A shearing gap 20 may be separated from flywheel ring 4 and radial flange 13 by shearing surfaces 18 and 19 that axially face each other and extend in the radial direction.

A damping space 17 may be completely filled with viscous medium 16, which may be a silicone oil, and spring bodies 6 and 9 and cover 24 may be made of a silicone-resistant synthetic rubber. It should be understood, however, that viscous media and elastic rubber materials different from the above may also be conceivable.

Damping space 17 may be essentially annular in shape, extend in a radial direction, and be limited on one side by premountable unit 10 in the axial direction and on the other side by radial flange 13 of the belt pulley 1 in the axial direction.

Damping space 17 may be sealed against the surroundings 21 by the two sealing rings 22 and 23. A radially inner first sealing ring 22 may merge together with first spring body 6 to form an integral assembly, and a radially outer second sealing ring 23 may merging similarly with second sealing body 9 to form another integral assembly.

First sealing ring 22 may be disposed under elastic pretension in sealing manner between hub ring 3 and radial flange 13, and second sealing ring 23 may be similarly disposed between bushing 7 and belt pulley 1.

Overall, the belt pulley having the integrated torsional oscillation damper is of simple configuration. From a fabrication standpoint, the belt pulley is easy to fabricate, and from an economic standpoint is inexpensive to produce.

To fabricate belt pulley 1 having integrated torsional oscillation damper 2, the following method may be used. After pot-shaped belt pulley 1 has been fabricated in a known manner and after premountable unit 10 has been produced, preferably in only a single processing step using a single vulcanization tool, viscous medium 16 may be introduced into pot-shaped belt pulley 1. In a second processing step, premountable unit 10 may be inserted into belt pulley 1 filled with medium 16. Premountable unit 10, after having been inserted, automatically seals damping space 17 against surroundings 21 by means of first and second sealing ring 22 and 23.

FIG. 1 shows a first configuration of a belt pulley 1 having an integrated torsional oscillation damper 2. Spring bodies 6 and 9, seen in the section presented here, may be rectangular. Spring bodies 6 and 9 may be optimized in terms of tension and stretching. Spring bodies 6 and 9 may extend in the axial direction over nearly the entire height of belt pulley 1, resulting in an optimum size of the bonding surfaces between spring bodies 6 and 9 and hub ring 3, fly-wheel ring 4 and bushing 7. As a result, shearing stresses in the boundary layers of the bonding surfaces may be minimized. Extension of spring bodies 6 and 9 in the radial direction may be sized sufficiently large to reliably control the shear stretching of spring bodies 6 and 9.

FIG. 2 shows a second configuration of a belt pulley 1 having an integrated torsional oscillation damper 2. Inner spring body 6, viewed in the section presented here, may be trapezoidal in shape, with spring body 6 having on a side facing away from radial flange 13, a greater radial thickness than on a side facing radial flange 13. During normal use of belt pulley 1, spring bodies 6 and 9 may heat up during operation, and the heat-induced expansion may cause back-pressure forces to build up within spring bodies 6 and 9, which may hold flywheel ring 4 reliably in its axial position, even at higher rotational speeds. This is advantageous because, as a result of the hydraulic pressure of the rotating viscous medium 16, flywheel ring 4 may tend to drift away from radial flange 13.

Cover 24 of shearing surface 18 of flywheel 4 may have a smooth surface or, for example, neppy elevations. The elevations under elastic pretension may contact shearing surface 19 of radial flange 13. This contact ensures a constant axial width of shearing gap 20, regardless of the hydraulic pressure prevailing during the use of belt pulley 1 having torsional oscillation damper 2.

What is claimed is:

1. A belt pulley comprising:
an integrated torsional oscillation damper comprising a flywheel ring enclosing a hub ring, a radial first space between said flywheel ring and said hub ring having a first spring body arranged therein, and a bushing enclosing said flywheel ring, a radial second space between said bushing and said flywheel ring having a second spring body arranged therein;
said hub ring, said first spring body, said flywheel ring, said second spring body, and said bushing forming a pre-mountable unit;
the belt pulley is pot-shaped and said pre-mountable unit is enclosed by an axial flange of the belt pulley having a belt track and a radial flange, an inner peripheral surface of said axial flange enclosing an outer peripheral surface of said bushing;
a damping space filled with a viscous medium defined by said pre-mountable unit and said radial flange;
a shearing gap filled with said viscous medium defined by shearing surfaces of said flywheel ring and said radial flange that axially face each other and extend in a radial direction; and
a radial inner sealing ring and a radial outer sealing ring for sealing said damping space, said radial inner sealing ring integral with said first spring body and said radial outer sealing ring integral with said second spring body.

2. The belt pulley according to claim 1, wherein said spring bodies are made of a rubber elastic material resistant to said viscous medium.

3. The belt pulley according to claim 1, wherein said spring bodies are made of a synthetic rubber and said viscous medium is a silicone oil.

4. The belt pulley according to claim 1, wherein said spring bodies are made of the same material.

5. The belt pulley according to claim 1, wherein said spring bodies are integral, and said shearing surface of said flywheel ring axially facing said radial flange is covered by a cover formed of a material that is the same as said sprig bodies.

6. The belt pulley according to claim 5, wherein at least one of said spring bodies and said cover is bonded with said flywheel ring.

7. The belt pulley according to claim 1, wherein said spring bodies, viewed in the longitudinal section, are rectangular.

8. The belt pulley according to claim 1, wherein at least one of said spring bodies, viewed in longitudinal section, is trapezoidal, and that said spring body on an axial side away from said radial flange has a greater radial thickness than on an axial side facing said radial flange.

9. The belt pulley according to claim 1, wherein said radial inner sealing ring is arranged between said hub ring and said radial flange.

10. The belt pulley according to claim 1, wherein said radial outer sealing ring is arranged between said bushing and said radial flange.

11. The belt pulley according to claim 1, wherein said radial flange and said hub ring are connected together in a torque proof manner.

12. A method for manufacturing the belt pulley according to claim 1, comprising:
filling said viscous medium into the pot-shaped belt pulley; and
inserting said pre-mountable unit into said pot-shaped belt pulley filled with said viscous medium.

13. A belt pulley comprising:
an axial flange having a track formed thereon;
a radial flange extending from said axial flange;
a pre-mountable torsional oscillation damper having hub ring, a flywheel ring, and a bushing;
a first spring body having a first sealing ring disposed in a gap between said hub ring and said flywheel ring;
a second spring body having a second sealing ring disposed in a gap between said flywheel ring and said bushing;
a damping space filled with a medium defined by said pre-mountable torsional oscillation damper and said radial flange,
wherein said first and second sealing rings seal said damping space.

14. The belt pulley of claim 13, wherein said first and second sealing rings are integral with said first and second spring bodies, respectively.

15. The belt pulley of claim 13, wherein said spring bodies are rectangular shaped when viewed in longitudinal section.

16. The belt pulley of claim 13, wherein one of said first and second spring bodies is trapezoidal shaped.

17. The belt pulley of claim 13, wherein said first and second spring bodies are connected.
